(19) United States
(12) Patent Application Publication
(10) Pub. No.: US 2015/0205269 A1
(43) Pub. Date: Jul. 23, 2015

(54) METHOD AND SYSTEM FOR MONITORING CONTROLLED VARIABLE OF MULTIVARIABLE PREDICTIVE CONTROLLER IN AN INDUSTRIAL PLANT

(71) Applicant: YOKOGAWA ELECTRIC CORPORATION, Tokyo (JP)

(72) Inventors: Sanjay Venugopal, Bangalore (IN); Adidev Katiyar, Bangalore (IN)

(73) Assignee: YOKOGAWA ELECTRIC CORPORATION, Tokyo (JP)

(21) Appl. No.: 14/457,342

(22) Filed: Aug. 12, 2014

(30) Foreign Application Priority Data
Jan. 21, 2014 (IN) 257/CHE/2014

(51) Int. Cl. G05B 13/02

(52) U.S. Cl. CPC G05B 13/026

(57) ABSTRACT

Embodiments of the present disclosure relates to a method and system for monitoring a controlled variable of a multi variable predictive controller in an industrial plant. The method comprises receiving predetermined tuning parameters and at least one gain value for the controlled variable from the data source. The method further comprises determining relationship indicator values by a processing unit based on predetermined functions. The inputs to the predetermined functions are the received predetermined tuning parameters and the at least one gain value. The relationship indicator values provide information about the relation between the controlled variable and the related process variables affecting the controlled variable. The controlled variable, related process variables affecting the controlled variable and the determined relationship indicator values are displayed on the GUI using which the operator monitors the controlled variable.

### CROSS-REFERENCE TO RELATED APPLICATION

The present application claims priority of Indian patent application serial number 257/CHE/2014 filed on Jan. 21, 2014, the entire contents of which are incorporated by reference.

### TECHNICAL FIELD

The present disclosure is generally related to process control in an industrial plant. More particularly, the disclosure pertains to a method and system for monitoring a controlled variable of a multivariable predictive controller (MVPC) in the industrial plant.

### BACKGROUND

In process control, information is gathered automatically from various sensors or other devices in an industrial plant and the gathered information is used to control various equipments for running the industrial plant. Various types of process control systems are presently in use, such as controllers capable of controlling multi-variable processes and for control of processes operable under control of a single variable.

Model-based predictive control technique is one of the process control system for controlling multi-variable processes. In model-based predictive control technique, a controller generally contains three types of process variables namely, controlled variables (CVs), manipulated variables (MVs), and disturbance variables (DVs).

In the conventional systems, a user of the model-based predictive controller is provided with various types of information related to process variables including information regarding controlled variables, manipulated variables, and disturbance variables by way of various interfaces and displays. Trend display, matrix table, bar graph and the grid display are the common form of displays provided to the user for monitoring and interacting with the controller. One of the problems associated with the conventional display techniques is that, as the number of process variables increase in the multi-variable predictive controller application, large amount of display area needs to be devoted to the presentation of textual data with respect to the process variables.

Further, at a given point of time the controlled variable can be affected by one or more manipulated variables and disturbance variables. Therefore, it is important to provide a means for operators to determine the impact of manipulated variable and disturbance variable on a controlled variable so that the operator may take required actions to monitor the controlled variable. The conventional display technique displays all the controlled variables, manipulated variables and the disturbance variables of a particular process of the plant as shown in FIG. 3. The problem associated with the display technique illustrated in FIG. 3 is that, the operator has to first formulate the textual data to decipher the relational information between the process variables and then take necessary actions on the manipulated variables to keep the controlled variable within constraints which is time consuming.

Therefore, there exists a need for a method and a system that addresses the above listed deficiencies. More particularly, the method and system for providing dynamic display and monitoring the controlled variable in the industrial plant.

### SUMMARY

The shortcomings of the prior art are overcome and many additional advantages are provided through the present disclosure. Additional features and advantages are realized through the techniques of the present disclosure. Other embodiments and aspects of the disclosure are described in detail herein and are considered a part of the claimed disclosure.

In one embodiment, the present disclosure relates to a method for monitoring a controlled variable of a multivariable predictive controller in an industrial plant. The method comprises receiving predetermined tuning parameters for the controlled variable from a data source, wherein the controlled variable is associated with at least one of a manipulated variable and a disturbance variable. The method also comprises receiving at least one gain value for the controlled variable. Upon receiving the predetermined tuning parameters and the at least one gain value, a processing unit determines a relationship indicator value based on a predetermined function wherein the inputs to the predetermined function are the received at least one gain value and the predetermined tuning parameters. The processing unit monitors the controlled variable based on the determined relationship indicator value.

In one embodiment, the present disclosure provides a graphical user interface for monitoring a controlled variable of a multivariable predictive controller (MVPC) in an industrial plant. The graphical user interface comprises a display area configured to display a relationship indicator value. The relationship indicator value is determined based on a predetermined function, wherein inputs to the predetermined function are at least one gain value for the controlled variable and predetermined tuning parameters for the controlled variable, wherein the controlled variable is associated with at least one of a manipulated variable and a disturbance variable.

In one embodiment, the present disclosure provides a system for monitoring a controlled variable of a multivariable predictive controller (MVPC) in an industrial plant. The system comprises a data source and a processing unit. The data source is configured to store predetermined tuning parameters and at least one gain value for the controlled variable, wherein the controlled variable is associated with at least one of a manipulated variable and a disturbance variable. The processing unit is configured to determine a relationship indicator value based on a predetermined function. The inputs to the predetermined function are the at least one of the gain value and the predetermined tuning parameters for monitoring the controlled variable of a multivariable predictive controller.

The aforementioned and other features and advantages of the disclosure will become further apparent from the following detailed description of the presently preferred embodiments, read in conjunction with the accompanying drawings. The detailed description and drawings are merely illustrative of the disclosure rather than limiting, the scope of the disclosure being defined by the appended claims and equivalents thereof.

### BRIEF DESCRIPTION OF THE DRAWINGS

The features of the present disclosure are set forth with particularity in the appended claims. The embodiments of the disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 shows a distributed network with components of a system connected over a plant information network according to an embodiment of the present disclosure;

FIG. 2 illustrates the system for monitoring a controlled variable of a multivariable predictive controller (MVPC) in an industrial plant in accordance with an embodiment of the present disclosure;

FIG. 3 shows Graphical User Interface (GUI) for monitoring process trend of a controlled variable in accordance with an embodiment of the prior art;

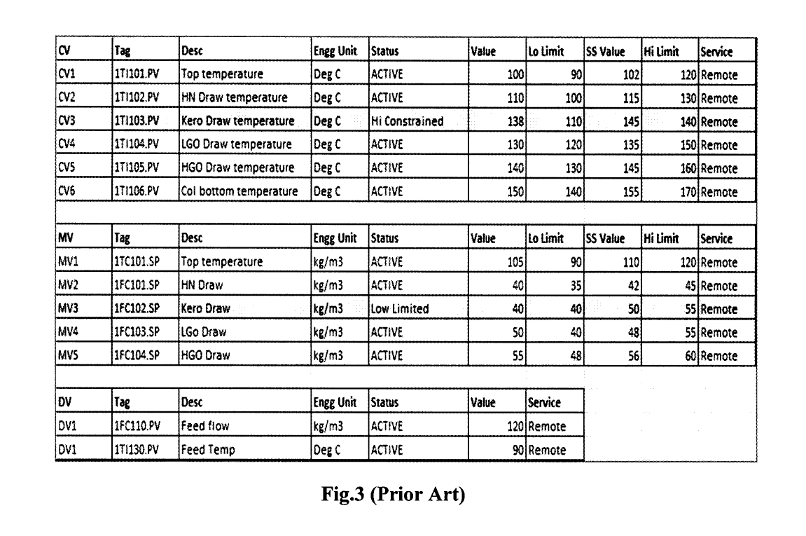

FIG. 4 shows GUI for monitoring a controlled variable of a MVPC in an industrial plant in accordance with an embodiment of the present disclosure; and

FIG. 5 shows a flow chart illustrating method for monitoring a controlled variable of a MVPC in an industrial plant in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

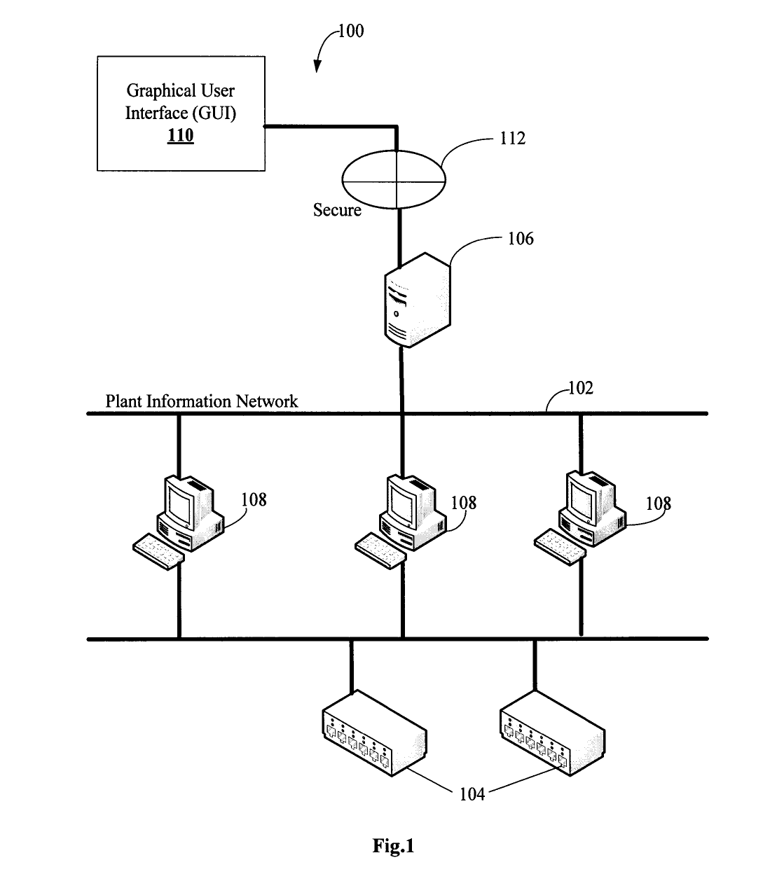

FIG. 1 shows a distributed network 100 with components of a system 200 (not explicitly shown in FIG. 1) connected over a plant information network 102 according to an embodiment of the present disclosure. The distributed network 100 comprises one or more data sources 104, a server 106 such as for Advanced Process Control (APC), one or more Object Linking and Embedding (OLE) for Process Control (OPC) servers 108 and a graphical user interface (GUI) 110 connected over the plant information network 102. The server 106 is connected to the GUI 110 through a secure network 112. The OPC servers 108 collect information including but not limited to engineering, process, event, log files and configuration data from the one or more data sources 104 of industrial plant. Each of the OPC servers 108 comprises an OPC Unified Architecture (UA) interface, Historical Data Access module, an Alarms and Events module and data access module which helps in consolidating data from different data sources 104 on a single platform as required by an operator of the industrial plant to control processes of the industrial plant. In a non-limiting aspect of the present disclosure, the OPC servers 108 may include OPC historical data access, OPC alarms and OPC batch.

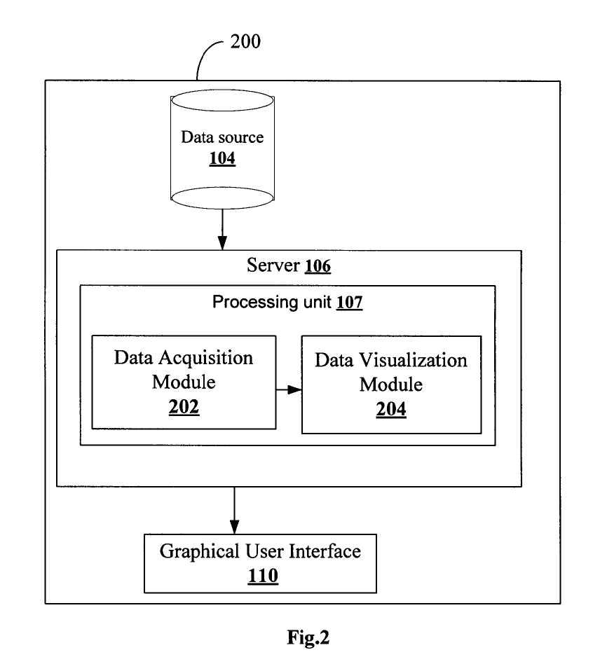

FIG. 2 illustrates the system 200 for monitoring a controlled variable of a multivariable predictive controller (MVPC) in an industrial plant in accordance with an embodiment of the present disclosure. The system 200 comprises the data sources 104, the server 106 and the GUI 110. The server 106 comprises a processing unit 107 having a data acquisition module 202 and a data visualization module 204. As an example, the industrial plant may be a chemical plant or an oil and gas refinery. The present disclosure is not limited to any particular industrial plant but is particularly advantageous in the control of a continuous multi-variable production processes. However, a person skilled in the art would recognize that the dynamic display method described herein are in no manner limited to multivariable processes or model based predictive controllers, but applicable to various controllers and various processes including single process variable controllers processes.

Each of the industrial plant comprises one or more processes and each of the one or more processes comprises one or more process variables namely controlled variables (CV), manipulated variables (MV) and disturbance variables (DV). The one or more processes includes but not limited to pressure, temperature, position, acceleration, velocity, power, current and fluid flow. In an industrial process environment, the controlled variables can be considered as output variables. The desired value of the controlled variables is often set at a predetermined value called a set point. The manipulated variables are considered as input variables to the process because they can be manipulated to vary the controlled variable. Disturbance variables are inputs that are not manipulated but can vary as a result of environment or external factors. The one or more process variables associated with each of the process is stored in the one or more data sources 104. The one or more process variables associated with each of the process contains parameters namely, a high limit value, low-limit value, a current value and a predictive value. The one or more data sources 104 includes but is not limited to a system controller, a simulator, a database and any other combinations of the data sources 104 which comprises one or more processes.

In an embodiment, the controlled variable of a particular process may be affected by one or more manipulated variables and the disturbance variables. The operator of the industrial plant should be provided with the information related to the affected controlled variable and the one or more manipulated variables and the disturbance variables affecting the controlled variable. The operator should be provided with this information so that the operator can take necessary counter measures to bring the affected controlled variable under control. To bring the affected controlled variable under control, the operator performs one or more actions on the one or more manipulated variables. The one or more actions are selected from a group comprising activating the one or more manipulated variables, modifying the current value of the one or more manipulated variables and modifying control information of the one or more manipulated variables. The operator should also be provided with the relationship indicator values. Based on the relationship indicator values, the operator can identify the one or more manipulated variables affecting the controlled variable. The relationship indicator value is determined based on predetermined functions. The inputs to the predetermined functions are the predetermined tuning parameters and at least one gain value. The predetermined tuning parameters and the at least one gain value are received by the processing unit 107 from the data sources 104.

In an embodiment, the related process variable having high relationship indicator value indicates that it has a more significant impact on the controlled variable compared to another related process variable having a low relationship indicator value. In one embodiment, one of the one or more related process variables can be used to control the selected controlled variable. By using the relationship indicator values, the operator can visualize the one or more manipulated variables and the disturbance variables affecting the controlled variable and then manipulate the manipulated variable to bring the controlled variable under control.

The data acquisition module 202 retrieves one or more current process variables of a particular process from the one or more data sources 104. The one or more current process variables are the controlled variables, manipulated variables and the disturbance variables. The operator selects one of the one or more current process variables. The data acquisition module 202 retrieves one or more related process variables for the selected current process variable. For example, if the operator selects a particular controlled variable, the related process variables are one or more manipulated and the disturbance variables associated with the selected controlled variable. The data acquisition module receives predetermined tuning parameters and at least one gain value for the selected controlled variable to determine the relationship indicator value from the data source. The data acquisition module determines the relationship indicator value based on a predetermined function wherein input to the predetermined function are the received predetermined tuning parameters and the at least one gain value. The determined relationship indicator values are further normalized using known techniques to obtain the normalized values. The data acquisition module 202 provides the selected current process variable, the related process variables associated with the selected controlled variable and the determined relationship indicator values to the data visualization module 204. The data visualization module 204 dynamically displays the determined relationship indicator values on the GUI 110. The data visualization module 204 also displays the selected controlled variable on a first display area of the GUI 110 and the related process variables on the second display area of the GUI 110. The data visualization module 204 displays the controlled variable, relationship indicator values and the related process variables on the GUI 110 in a predefined format. In an embodiment, the predefined format is the graphical format. The GUI 110 is updated at every controller execution by the data visualization module 204 based on the parameters of the selected controlled variable and the related process variables.

In an embodiment, the GUI 110 also displays one or more information related to the process variables like state of the process variables such as ACTIVE state and INACTIVE state, access of the process variables such as REMOTE and LOCAL and constraint information of the process variables such as HIGH CONSTRAINT and LOW CONSTRAINT.

The server 106 communicates with the GUI 110 via one or more intervening secure networks 112. The intervening network(s) 112 comprise a public network e.g., the Internet, World Wide Web, etc. or private network e.g., local area network (LAN), etc. or combinations thereof e.g., a virtual private network, LAN connected to the Internet, etc. Furthermore, the intervening network 112 need not be a wired network only, and may comprise wireless network elements as known in the art. In the illustrated embodiment, the dynamic relation display interface 110 include hand-held devices, multiprocessor systems, microprocessor-based or programmable consumer electronics, network Personal Communication Service (PCS), minicomputers, mainframe computers, and the like.

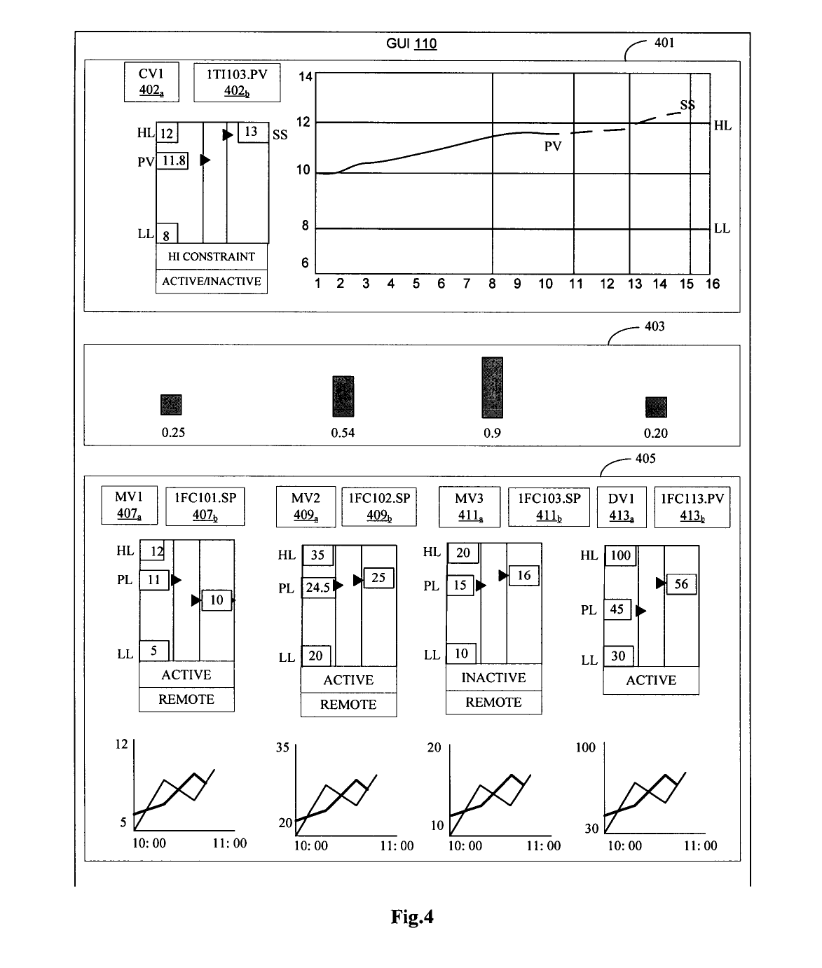

FIG. 4 shows GUI 110 for monitoring a controlled variable of a MVPC in an industrial plant in accordance with an embodiment of the present disclosure. The GUI 110 displays selected controlled variable on a first display area 401, the relationship indicator values on a second display area 403 and the related one or more process variables on a third display area 405.

For the purpose of illustration, consider that the operator wishes to monitor a controlled variable CV1 402ₐ. The controlled variable CV1 is associated with a tag name namely 1TI103.PV 402_{b}. The controlled variable CV1 402ₐ is associated with a process parameter. When the operator selects CV1 402ₐ, the associated parameters namely, a high limit value (HL), low limit value (LL), a current value (SS) and a predicted value (PV) are displayed on the first display area 401 of the GUI 110. The first display area 401 also displays tag name associated with the CV 402ₐ. In an embodiment, the first display area 401 may also display information related to status of the selected process variable such as ACTIVE or INACTIVE. In an embodiment, the first display area 401 may also display information related to constraint of the selected controlled variable CV1 402ₐ as either High constraint or Low constraint.

As an example, the preconfigured high limit (HL) value for CV1 402ₐ is 12, the preconfigured low limit (LL) value is 8, the current value (SS) is 13 and the predicted value (PV) is 11.8. The controlled variable CV1 402ₐ is associated with one or more related process variable. The one or more related process variables are three manipulated variables MV1 407ₐ, MV2 409ₐ and MV3 411ₐ and a disturbance variable DV1 413ₐ. MV1 407ₐ, MV2 409ₐ, MV3 411ₐ and DV1 413ₐ are displayed in the third display area 405 of the GUI 110. The manipulated variable MV3 411ₐ may be in INACTIVE state. The data acquisition module 204 receives the gain values and the predetermined tuning parameters for the controlled variable CV1 402ₐ. The gain value of MV1 407ₐ is −0.5, gain value of MV2 409ₐ is +0.74 and gain value of DV1 413ₐ is +0.45. The predetermined tuning parameters associated with manipulated variables are MV speed value and MV max step size value. The MV speed value of MV1 407ₐ is 0.6 and the MV speed value of MV2 409ₐ is 0.4. The MV max step size value of MV1 407ₐ is 0.5 and the MV max step size value of MV2 409ₐ is 0.75. Table 1 below provides examples of the gain values and predetermined tuning parameters for determining relationship indicator values.

TABLE 1

| | | MV1 407ₐ | MV2 409ₐ | DV1 413ₐ |
|---|---|---|---|---|
| Gain Value (CV1 402ₐ) | | −0.5 | +0.74 | +0.45 |
| Current Value (SS) | | 10 | 25 | 0.9 |
| Lo Limit Value (LL) | | 5 | 20 | — |
| Hi Limit Value (HL) | | 12 | 35 | — |
| Tuning Parameter | MV Speed | 0.6 | 0.4 | — |
| | MV max step | 0.5 | 0.75 | — |
| | size | | | |

Upon receiving the gain values and the predetermined tuning parameters, the data acquisition module 202 determines the relationship indicator values using one or more predetermined functions.

In an example, the relationship indicator value is obtained by squaring the gain value of the manipulated variables in a predetermined function namely (MV gain). The gain value of MV1 407ₐ is −0.5. Therefore, the relationship indicator value is 0.25. Similarly, the gain value of MV2 409ₐ is 0.74. The predetermined function for obtaining the relationship indicator value is (MV gain)². Therefore, the relationship indicator value is 0.5476.

In yet another example, the predetermined function used to determine the relationship indicator value is (MV Gain)²*MV Speed. The relationship indicator value for MV1 407ₐ is (−0.5)²×0.6=0.15, the relationship indicator value for MV2 409ₐ is (0.74)²×0.4=0.219.

In another example, the predetermined function used to determine the relationship indicator value is (MV Gain)²*MV Speed*MV Max Move. Therefore, the relationship indicator value for MV1 407ₐ is (−0.5)²×0.6×0.5=0.075 and the relationship indicator value for MV2 409ₐ is (0.74)²×0.4×0.75=0.164.

Considering the first example, the relationship indicator value for MV1 407ₐ is 0.25 and for MV2 409ₐ is 0.5476. The data visualization module 204 displays the relationship indicator values on the second display unit 403 of the GUI 110. In view of the above example one can infer that the predetermined function used to determine relationship indicator value is not constant. The predetermined function is decided based on the process needs to be controlled. Alternatively, there might exist more than one predetermined function for the same process in order to determine the relationship indicator value. Table 2 below provides examples of the exemplary predetermined functions the relationship indicator values.

TABLE 2

| | MV1 407ₐ | MV2 409ₐ | DV1 413ₐ |
|---|---|---|---|
| Predetermined | (MV1 Gain)² | (MV2 Gain)² | (DV1 Gain)² |
| Function_01 | | | |
| Relationship | (−0.5)² = | (0.74)² = | (0.45)² = |
| Indicator Value | 0.25 | 0.5476 | 0.2025 |
| Predetermined | (MV1Gain)² * | (MV2 Gain)² * | — |
| Function_02 | MV1 Speed) | MV2 Speed) | |
| Relationship | (−0.5)² × | (0.74)² × | — |
| Indicator Value | 0.6 = 0.15 | 0.4 = 0.219 | |
| Predetermined | (MV1 Gain)² * | (MV2 Gain)² * | — |
| Function_03 | MV1 Speed * MV | MV2 Speed * MV | |
| | max step size) | max step size) | |
| Relationship | (−0.5)² × | (0.74)² × 0.4 × | — |
| Indicator Value | 0.6 × 0.5 = 0.075 | 0.75 = 0.164 | |

The data visualization module 204 displays the related process variables such as MV1 407ₐ, MV2 409ₐ, MV3 411ₐ and DV1 413ₐ on the third display area 405 of the GUI 110.

In the third display area 405, the parameters related to each of the related process variables namely, a related high limit value, a related low limit value, a related current value and the related predicted value are displayed. The third display area 405 also displays status of each of the related process variables such as ACTIVE or INACTIVE. The third display area 405 further displays information related to access of the related process variables such as LOCAL or REMOTE. If the related process variable cannot be accessed by the operator, then the access information is displayed as REMOTE in the third display area 405. If the related process variable can be accessed by the operator, then the access information is displayed as LOCAL in the third display area 405.

Upon viewing the GUI 110, the operator visualizes that the predicted steady state value of CV1 402ₐ is more than the high limit value. Therefore, the operator has to manipulate one or more of the related process variables to control the controlled variable. The relationship indicator value 0.25 is the representative value of the impact of manipulated variable MV1 407ₐ on the controlled variable CV1 402ₐ. MV1 407ₐ has the tag name 1FC101.SP 407_{b} displayed in the third display area 405. The relationship indicator value 0.54 is the representative value of the impact of manipulated variable MV2 409ₐ on the controlled variable CV1 402ₐ. The manipulated variable MV2 409ₐ has the tag name 1FC102SP 409_{b} displayed in the third display area 405. The relationship indicator value 0.9 is the representative value of the impact of manipulated variable MV3 411ₐ on the controlled variable CV1 402ₐ. The manipulated variable MV3 411ₐ has the tag name 1FC103.SP 411_{b} displayed in the third display area 405. The disturbance variable DV1 413ₐ affects the controlled variable CV1 402ₐ due to which the current value of CV1 402a is more than the predicted value. But, the operator cannot manipulate the disturbance variable DV1 413ₐ to control the controlled variable CV1 402ₐ. The relationship indicator value 0.20 is the representative value of the impact of the disturbance variable DV1 413ₐ on the controlled variable CV1 402ₐ. From the relationship indicator values, the operator visualizes that, the manipulated variable MV3 411ₐ having the tag name 1FC103.SP 411_{b} has the highest relationship indicator value with the current process variable CV1 402ₐ. The operator may consider manipulating the manipulated variable having the tag name 1FC103.SP 411_{b} to control the current process variable CV1 402ₐ. But the operator visualizes from the third display area 405 that, the manipulated variable MV3 411ₐ is in INACTIVE state and hence it cannot be used to control CV1 402ₐ. Preferably, the operator manipulates the manipulated variable MV2 409ₐ having the tag name 1FC102.SP 409_{b} to control the current process variable CV1 402ₐ at the quickest possible time. In this manner, the operator can effectively monitor controlled variable CV 1 402ₐ.

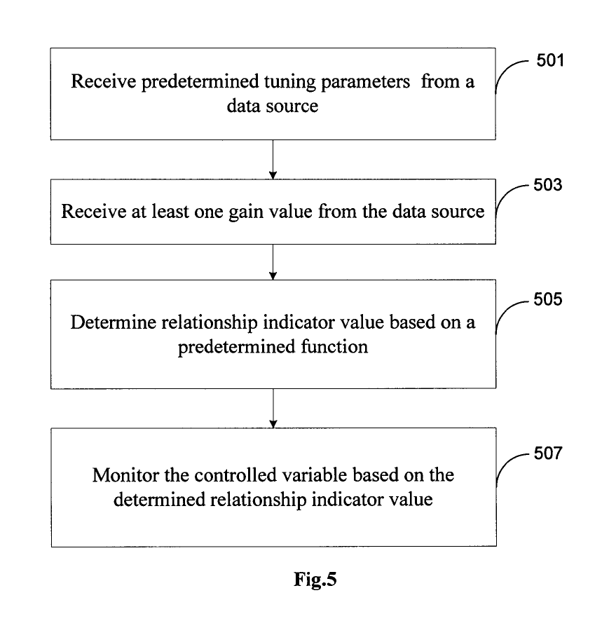

FIG. 5 shows a flow chart illustrating method for monitoring a controlled variable of a MVPC in an industrial plant in accordance with an embodiment of the present disclosure. At step 501, the processing unit 107 receives the predetermined tuning parameters for the controlled variable from the data source 104. The processing unit 107 also receives at least one gain value for the controlled variable at step 503. Thereafter, the processing unit 107 determines the relationship indicator value based on a predetermined function at step 505. The inputs to the predetermined functions are the received tuning parameters and the at least one gain value. The processing unit 107 displays the determined relationship indicator values on the GUI 110. The processing unit 107 also displays the controlled variable and its parameters in the first display area 401 of the GUI 110 and related process variables and its parameters in the second display area of the GUI 110. Based on the determined relationship indicator values, the operator determines the related process variable affecting the controlled variable and monitors the controlled variable at step 507.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processing unit may read and execute the code from the computer readable medium. The processing unit is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

Additionally, advantages of present disclosure are illustrated herein.

The present disclosure provides a method for dynamic visualization of MVPC variables.

The present disclosure provides a method for monitoring the controlled variable in the quickest possible time.

The present disclosure provides a method for determining relationship indicator values using which the operator controls the controlled variable.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Description | Reference Number |
|---|---|
| Distributed Network System | 100 |
| Plant Information Network | 102 |
| Data Source | 104 |
| Server | 106 |
| OPC servers | 108 |
| Graphical user interface | 110 |
| Secure Network | 112 |
| System | 200 |
| Data Acquisition module | 202 |
| Data Visualization module | 204 |
| First Display Area | 401 |
| Second Display Area | 403 |
| Third Display Area | 405 |

1. A method for monitoring a controlled variable of a multivariable predictive controller (MVPC) in an industrial plant, the method comprising:
receiving, from a data source, predetermined tuning parameters for the controlled variable, wherein the controlled variable is associated with at least one of a manipulated variable and a disturbance variable;
receiving, from the data source, at least one gain value for the controlled variable; and
determining a relationship indicator value, by a processing unit, based on a predetermined function, wherein inputs to the predetermined function are the received at least one gain value and the predetermined tuning parameters for monitoring the controlled variable of the multivariable predictive controller.

2. The method as claimed in claim 1 further comprising providing, on a graphical user interface, one or more controlled variables for selection of at least one controlled variable.

3. The method as claimed in claim 2 further comprising displaying the determined relationship indicator value associated with the selected controlled variable.

4. The method as claimed in claim 2 further comprising displaying at least one of a high limit, a low limit, a current value and a predicted value of the selected controlled variable.

5. The method as claimed in claim 1 further comprising performing one or more operations based on the determined relationship indicator value.

6. The method as claimed in claim 1 further comprising multiplying gain value with a predetermined weight parameter.

7. The method as claimed in claim 1, wherein determining the relationship indicator value further including a manipulated variable step size in the inputs of the predetermined function.

8. The method as claimed in claim 1 further comprising multiplying predetermined tuning parameters with a predetermined weight parameter.

9. The method as claimed in claim 1 further comprising normalizing the relationship indicator value to a predetermined scale.

10. A graphical user interface for monitoring a controlled variable of a multivariable predictive controller (MVPC) in an industrial plant comprising:
a display area configured to display a relationship indicator value, wherein the relationship indicator value is determined based on a predetermined function, wherein inputs to the predetermined function are:
predetermined tuning parameters for the controlled variable, wherein the controlled variable is associated with at least one gain value for the controlled variable; and at least one of a manipulated variable and a disturbance variable.

11. The graphical user interface as claimed in claim 10, wherein the display area further comprising a first display area displaying at least one of a high limit value, a low limit value, the current value and a predicted value of the selected controlled variable.

12. The graphical user interface as claimed in claim 10, wherein the display area further comprising a second display area displaying at least one of a high limit value, a low limit value and a current value of at least one of the manipulated variable and the disturbance variable.

13. The graphical user interface as claimed in claim 12 further comprising displaying status information associated with the at least one of the manipulated variable and the disturbance variable in the second display area.

14. The graphical user interface as claimed in claim 10, wherein the display area is configured to associate the relationship indicator value with the corresponding manipulated variable.

15. The graphical user interface as claimed in claim 10, wherein the display area is configured to associate the relationship indicator value with the corresponding disturbance variable.

16. A system for monitoring a controlled variable of a multivariable predictive controller (MVPC) in an industrial plant comprising:
a data source configured to store predetermined tuning parameters and at least one gain value for the controlled variable, wherein the controlled variable is associated with at least one of a manipulated variable and a disturbance variable; and
a processing unit configured to determine a relationship indicator value based on a predetermined function wherein inputs to the predetermined function are the at least one gain value and the predetermined tuning parameters for monitoring the controlled variable of a multivariable predictive controller.

17. The system as claimed in claim 16, wherein the data source is at least one of a system controller, a simulator and a database.

18. The system as claimed in claim 16, wherein the processing unit comprises a data acquisition module and a data visualization module.

19. A non-transitory computer readable medium including operations stored thereon that when processed by at least one processing unit cause a system to perform the acts of:
receiving, from a data source, predetermined tuning parameters for the controlled variable, wherein the controlled variable is associated with at least one of a manipulated variable and a disturbance variable;
receiving, from the data source, at least one gain value for the controlled variable; and
determining a relationship indicator value based on a predetermined function, wherein inputs to the predetermined function are the received at least one gain value and the predetermined tuning parameters for monitoring the controlled variable of the multivariable predictive controller.
